(19) United States
(12) Patent Application Publication
(10) Pub. No.: US 2026/0338255 A1
(43) Pub. Date: Oct. 29, 2026

(54) ARTICLE, IN PARTICULAR DRIVE BELT, WITH A TEXTILE COVERING

(71) Applicant: ContiTech Deutschland GmbH, Hannover (DE)

(72) Inventors: Timo Sebastian Kasak, Langenhagen (DE); Stephanie Kautz, Hannover (DE)

(73) Assignee: ContiTech Deutschland GmbH, Hannover (DE)

(21) Appl. No.: 19/109,136

(22) PCT Filed: Aug. 15, 2023
(86) PCT No.: PCT/DE2023/200166

§ 371 Date: Mar. 6, 2025

(51) Int. Cl. F16G 1/10

(52) U.S. Cl. CPC F16G 1/10

(57) ABSTRACT

An article including an elastomeric main body on the basis of at least one rubber compound with a surface of the article that is susceptible to noise and wear and is provided with a textile covering. The textile covering of the elastomeric article contains fibers of lyocell or consists entirely of fibers of lyocell.

The invention relates to an article comprising an elastomeric main body on the basis of at least one rubber compound with a surface of the article that is susceptible to noise and wear and is provided with a textile covering.

An article exposed to dynamic stresses, and therefore to wear and noise development, is for example a band, strap, belt, hose, air spring bellows, expansion joint or a multilayered fabric web, with the belt in the form of a drive belt being of particular importance. The elastomeric main body of the drive belt in this case comprises a top ply as the belt backing and a substructure with a force transfer zone.

Articles comprising an elastic main body are provided with a textile covering on the surface to adjust the product properties. In addition to wear resistance and noise behavior, in the case of the drive belts this also includes improved power transfer. Problems arise when these articles are to be used or must be used in a damp environment. At the moment, it is then no longer possible to meet the requirements for all the required physical properties to the same extent.

The object of the present invention is thus to provide an article comprising an elastomeric main body which has at least one textile covering on at least one surface of the article and whose physical properties remain at a good level even when there is dampness or in a damp environment. Advantageously, the material for the textile coating is also completely or partially based on sustainable and/or renewable raw materials.

The object is achieved by the fact that the textile covering of the elastomeric article contains fibers of lyocell or consists entirely of fibers of lyocell.

The terms “elastomeric article” and “article comprising an elastomeric main body” are used synonymously in this document.

Good properties in a wet or damp environment are already known from naturally occurring cellulose-based fibers, such as for example cotton. However, these properties result essentially from the special surface structure of the natural fibers. Previous attempts at mimicking this type of fiber in the form of other regenerated fibers, such as for example viscose, have found however that considerable deteriorations in the wet properties occurred. In this respect, it has very surprisingly been found that the use of lyocell fibers as a textile covering in elastomeric articles has an advantageous effect on use in a damp or wet environment.

At the same time, the use of lyocell makes an important contribution to sustainability.

Lyocell (CLY) is a cellulose fiber of regenerated cellulose, which is produced by the lyocell process (direct solvent process). The solvent used in the production process can be recovered almost completely. This is accompanied by a drastic reduction in environmentally harmful waste materials compared to conventional cellulose man-made fibers (such as viscose). It is mainly produced from wood from sustainable forestry and is biodegradable.

The structure of the lyocell fibers differs from the structure of viscose. Special features are long crystallites, reduced clustering and elongated cavities. There are also differences in the fiber structure. Lyocell fibers consist of equally thick fibrils distributed over the cross section.

The lyocell fibers may be formed as staple fibers or as filament fibers.

In an advantageous configuration, the textile covering consists entirely of lyocell fibers, i.e. the proportion of lyocell fibers is 100% in % by weight.

However, it is similarly also possible that the textile covering contains lyocell fibers, preferably in amounts of 20 to 95% by weight.

Preferably, the textile covering, which consists of lyocell fibers or contains lyocell fibers, is formed as a knitted fabric. If the textile covering consists of lyocell fibers, the weight per unit area is preferably between 70 g/m² and 350 g/m² and most particularly preferably between 100 g/m² and 250 g/m².

If the textile covering contains lyocell fibers, at least one further material may also be contained in amounts of 5% by weight to 80% by weight.

If the lyocell fibers are used in combination with at least one further material, this is referred to as a hybrid system or hybrid fiber construction.

Materials used for the at least one further material of the textile covering may be any of the suitable textile materials known in the art, which are preferably selected from the group consisting of: polyethylene (PE), such as for example UHMWPE, LDPE and LLDPE, or polyamide (PA), for example PA5.6, PA4.10, PA6, PA6.6, PA11, PA12, PA6.10 and PA6.12, or copolyamides or polyester (PES) or rayon or polyethylene terephthalate (PET) or polyethylene naphthalate (PEN) or polybutylene terephthalate (PBT) or polycarbonate (PC) or unsaturated polyester resin (UP) or poly(1,4-cyclohexanedimethylterephthalate) (PCDT) or natural fibers, such as for example wool, linen, hemp, cotton, or polyvinyl alcohol (PVAL) or polyoxibenzonaphthoate or polyvinyl acetal (PVA) or polyketone (POK) or polyether ether ketone (PEEK) or polyethylene 2,6-naphthalate (PEN) or polyphenylene or polyphenylene oxide (PPO) or polyphenylene sulfide (PPS) or polphenylene ether or polybenzoxazole (PBO) or polyoxadiazole (POD) or polyetherimide (PEI) or m-aramid or p-aramid or polypropylene or melamine or highly crystalline polymer fibers or polyurethane (TPU). The stated materials can also be used in recycled form, i.e. as recovered material.

The textile covering may be formed as a felt, fleece, woven fabric, braid, knitted fabric or laid web. If the elastomeric article is a drive belt, the textile covering is preferably formed as a woven fabric or knitted fabric.

All rubbers known to the skilled person may be used individually or in combination as a rubber compound for the rubber compound of the main body. Often rubbers are also referred to as elastomers, so that both terms are used synonymously in this document.

The rubber is preferably chosen from the group consisting of ethylene-propylene copolymer (EPM) and/or ethylene-propylene-diene copolymer (EPDM) and/or nitrile rubber (NBR) and/or (partially) hydrogenated nitrile rubber (HNBR) and/or fluoro rubber (FKM) and/or chloroprene rubber (CR) and/or natural rubber (NR) and/or styrene-butadiene rubber (SBR) and/or isoprene rubber (IR) and/or butyl rubber (IIR) and/or bromobutyl rubber (BIIR) and/or chlorobutyl rubber (CIIR) and/or butadiene rubber (BR) and/or chlorinated polyethylene (CM) and/or polyepichlorohydrin (ECO) and/or ethylene-vinyl acetate rubber (EVA) and/or acrylate rubber (ACM) and/or ethylene-acrylate rubber (AEM) and/or silicone rubber (MQ VMQ PVMQ FVMQ) and/or fluorinated methylsilicone rubber (MFQ) and/or perfluorinated propylene rubber (FFPM) and/or perfluorocarbon rubber (FFKM) and/or elastomeric polyurethane (PU).

If the article is in particular a drive belt, EPDM, EPM, NBR and HNBR are preferably used alone or in combination.

It is however also possible that the rubber compound contains at least another thermoplastic elastomer and/or also at least another thermoplastic, such as for example polyvinyl chloride (PVC), in amounts of 0 to 50 phr, preferably in amounts of 1 to 50 phr.

Further ingredients of the compound are usually also crosslinking agents, such as for example sulfur, sulphur donors or peroxides, fillers, such as for example carbon black and/or silica, processing aids, plasticizers, anti-aging agents and, if necessary, further additives (for example color pigments). Reference is made in this regard to the general prior art in rubber compound technology.

In an advantageous configuration, the elastomeric article may also contain at least one further embedded reinforcing element. Embedded means that the reinforcing element is not on the surface. The embedded reinforcing element may take the form of a cord, as a felt, fleece, woven fabric, braid, knitted fabric or laid web.

If the elastomeric article is a drive belt, the embedded reinforcing element preferably takes the form of a cord, i.e. it is formed in a so-called cord construction.

The invention will now be explained in detail with the aid of comparative examples and exemplary embodiments, which are summarized in Tables 1 to 4.

One drive belt was produced in each case, and provided with a corresponding textile covering. The textile coverings consist of the material specified in the respective table.

The physical properties that are particularly important for a textile covering of a drive belt that transfers torque by frictional engagement are, inter alia, the degree of slippage occurring in the power transfer or the coefficient of friction of the surface provided with the textile covering. They also include parameters such as the misalignment of individual strands or the load bearing at a drive pulley, which can be used to determine the state of occurrence of unwanted noises caused by the contact surface of the belt in relation to the pulley.

Since the object of the present invention is to improve the wet properties of an article, the results of the physical investigations under conditions with high ambient humidity are presented.

The physical investigations include the determination of the coefficient of friction (CoF) in dampness according to SAE standard J2432 and the measurements to evaluate the noise behavior and the slipping behavior.

The noise behavior is measured in three phases. What they have in common is that a belt is driven by a drive pulley at a speed n that has a rotational irregularity of 10%.

In a dry measurement, a pulley A is displaced in relation to a pulley B steplessly by at most 5 mm (corresponding to 2.86° misalignment of the strand between A and B) and the angle from which specific, misalignment-related noises occur at the entry to pulley B is determined. In this measurement, there is no power transfer in the belt drive.

A wet measurement is performed with power output at a generator adjusted in increments of 10 A between at least 30 A and at most 120 A on the basis of the current intensity output. At the beginning of each stage, water is injected into the strand upstream of the generator pulley, in variant 1 for 2 seconds at 20 ml/min, in variant 2 for 10 seconds at 300 ml/min.

In the slippage-power measurement, the power transferred by a frictionally engaging belt is determined by the resulting belt slippage.

In the measurement on which the test results are based, the described relationship is determined on a V-ribbed belt pulley with a pulley diameter customary for generators in ancillary units of passenger car engines and 120° wrap-around, with continuous water injection.

TABLE 1
Coefficient of friction (CoF) in the belt drive in dampness

| | Textile covering of | | |
|---|---|---|---|
| | Cotton | Lyocell | Viscose |
| Weight per unit area | (CO) | (CLY) | (CV) |
| approx. 210 to 230 | 1.03 | 1.09 | 0.95 |
| g/m² | | | |
| approx. 150 to 160 | 0.99 | 1.01 | — |
| g/m² | | | |

The textile covering according to the invention, of a lyocell knitted fabric, shows a visible improvement in the coefficient of friction (determined when there is 100% slippage) under damp ambient conditions in comparison with a cotton and viscose knitted fabric of identical construction and similar weight per unit area. In this case, a higher coefficient of friction means a greater power transfer capability.

TABLE 2
Noise testing (variant with 210 . . . 230 g/m² weight per unit area)

| | | Cotton | | Lyocell | | Viscose |
|---|---|---|---|---|---|---|
| | | textile | | textile | | textile |
| Type of test | Criterion | covering | | covering | | covering |
| Dry with strand | Misalignment reached | >2.86° | | >2.86° | | >2.86° |
| misalignment | (max. 2.86, limited by test | | | | | |
| | bench) | | | | | |
| | Type of noise | None | | None | | None |
| Water injection | Load reached before | >120 | A | >120 | A | 30 A |
| 20 ml/min | noises occur | | | | | |
| | Type of noise | None | | None | | Squealing |
| Water injection | Load reached before | 60 . . . 70 | A | 70 | A | 30 A |

| | | | | |
|---|---|---|---|---|
| 300 ml/min | noises occur | | | |
| | Type of noise | Squealing | Squealing | Squealing |

TABLE 3
Noise testing (variant with 150 . . . 160 g/m² weight per unit area)

| | | Cotton | | Lyocell | |
|---|---|---|---|---|---|
| | | textile | | textile | |
| Type of test | Criterion | covering | | covering | |
| Dry with | Misalignment | >2.86° | | >2.86° | |
| strand | reached (max. 2.86, | | | | |
| misalignment | by test limited bench) | | | | |
| | Type of noise | None | | None | |
| Water | Load reached before | >120 | A | >120 | A |
| injection | noises occur | | | | |
| 20 ml/min | Type of noise | None | | None | |
| Water | Load reached before | 30 . . . 40 | A | 50 . . . 60 | A |

| | | | |
|---|---|---|---|
| injection | noises occur | | |
| 300 ml/min | Type of noise | Squealing | Squealing |

An improvement in the noise behavior of a lyocell textile covering when there is wetness in the drive can also be seen (Tables 2 and 3). This advantage becomes more pronounced especially when there is a reduction in the weight per unit area of the textile (Table 3), which results in identical wet properties being achieved while using less material than in the case of comparable cellulose-based cotton textiles. This also saves resources.

TABLE 4
Belt slippage when transferring different power in dampness

Textile covering of

| Power | Cotton (CO) | Lyocell (CLY) | Viscose (CV) |
|---|---|---|---|
| 0.5 kW | 0.3% | 0.3% | 0.3% |
| 1.0 kW | 0.6% | 0.5% | 0.6% |
| 1.5 kW | 0.9% | 0.8% | 1.0% |
| 2.0 kW | 1.2% | 1.0% | 1.4% |
| 2.5 kW | 1.8% | 1.4% | 100.0% |
| 3.0 kW | 100.0% | 2.4% | — |
| 3.5 kW | — | 100.0% | — |

TABLE 5
Transferable power with different belt slippage in dampness

Textile covering of

| Slippage | Cotton (CO) | Lyocell (CLY) | Viscose (CV) |
|---|---|---|---|
| 1.0% | 1.8 kW | 2.0 kW | 1.5 kW |
| 1.5% | 2.4 kW | 2.6 kW | 2.1 kW |
| 2.0% | 2.6 kW | 2.8 kW | 2.2 kW |

Tables 4 and 5 show that a V-ribbed belt provided with the textile covering according to the invention can transfer significantly more power with the same slippage than a belt of comparable construction with a textile covering of viscose or cotton.

1. An article comprising an elastomeric main body on the basis of at least one rubber compound with a surface of the article that is susceptible to noise and wear and is provided with a textile covering, characterized in that the textile covering of the elastomeric article contains fibers of lyocell or consists entirely of fibers of lyocell.

2. The article as claimed in claim 1, wherein the textile covering has an average weight per unit area between 70 g/m2 and 350 g/m2.

3. The article as claimed in claim 1, wherein the textile covering is a knitted fabric.

4. The article as claimed in claim 1, wherein it also contains at least one embedded reinforcing element.

5. The article as claimed in claim 1, wherein it is a band, strap, belt, hose, air spring bellows, expansion joint or a multilayered fabric web.

6. The article as claimed in claim 5, wherein the belt is a drive belt.
